(19) United States
(12) Patent Application Publication
(10) Pub. No.: US 2007/0110031 A1
(43) Pub. Date: May 17, 2007

(54) Automated connection to a VOIP session

(75) Inventor: Christopher T. Szeto, Sunnyvale, CA (US)

Correspondence Address: DARBY & DARBY P.C., P.O. BOX 5257, NEW YORK, NY, 10150-6257, US

(73) Assignee: Yahoo! Inc., Sunnyvale, CA (US)

(21) Appl. No.: 11/274,431

(22) Filed: Nov. 15, 2005

(51) Int. Cl. H04L 12/66

(52) U.S. Cl. 370/352; 370/401

(57) ABSTRACT

A system, method, and apparatus are directed to status-based automatic answering and conferencing for presence-enabled VOIP communications. A first device may send a message to a plurality of devices indicating that it is available for an automatic VOIP connection. The message may be sent based, in part, on a contact list, buddy list, or the like, associated with the first device. The message may also include a topic, event, or talk show. When the second device places a VOIP call to the first device, the first device automatically answers the call and establishes an active VOIP session over the VOIP connection. A display may indicate that the user of the second device is listening. In addition, a third device may also place a VOIP call to the first device, which is automatically answered to establish at least a three-way VOIP conferencing session.

### BACKGROUND OF THE INVENTION

The present invention relates generally to network communications, and more particularly, but not exclusively, to a system and method for automatically managing a Voice Over Internet Protocol (VOIP) connection between users.

Internet Protocol (IP) Telephony, also known as VOIP, is a technology that makes it possible to have a voice conversation over an IP network, such as the Internet, instead of a dedicated voice transmission line. Depending on the service, one way to place a VOIP call is to employ specialized phones, sometimes called IP Phones, or VOIP phones, that may look like a normal phone. Such VOIP phones may connect to the network through an RJ-45 connector, or operate through a wireless connection. Another way to place a VOIP call includes use of a software application running on a personal computer.

Because VOIP makes it possible to have voice conversations over IP networks, VOIP may allow for a cost effective alternative to the traditional public switched telephone networks (PSTNs). Because of its relatively lower costs, VOIP phone services have been rapidly increasing in popularity. However, while VOIP may be a cost effective alternative, the manner in which a user may place a VOIP phone call may remain complicated and sometimes confusing. Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a client device that may be included in a system implementing the invention;

FIG. 3 illustrates a logical flow diagram generally showing one embodiment of a process for automatically managing a VOIP connection over a network; and

FIGS. 4-9 illustrate embodiments of possible screen displays displayable during an automatic VOIP connection, in accordance with the present invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The term “connection” refers to a collection of links and/or software elements that enable a computing device to communicate with another computing device over a network. One such connection may be a TCP connection. However, the invention is not limited to TCP connections, and other types of connections that enable a VOIP session to be established.

In traditional VOIP mechanisms, a user may have to first click a call button to initiate a call. The caller may then have to wait until the recipient then is notified of the call, either via a sound or graphic. The recipient must then select to accept or deny the call. In some instances, the caller may first elect to send a message to the recipient to determine whether the recipient is even available to accept a VOIP call. Such delays and/or inefficiencies in employing VOIP may be minimized using the present invention. The present invention however, is directed towards simplifying this interaction.

Briefly stated, the present invention is directed towards a system, method, and apparatus for status-based automatic answering and conferencing for presence-enabled VOIP communications. A first computing device may be configured to send to a plurality of computing devices a status message indicating that the first computing device is available for an automatic VOIP connection. That is, the user of the first computing device is indicating, in part, by the status message, that the user is present and available to participate in a VOIP communications.

In one embodiment, the status message is sent based, in part, on a contact list, buddy list, or the like, associated with the first computing device. However, the invention is not so limited, and the status message may be sent based on a variety of other criteria, and/or address sources. When a second computing device from the plurality of computing devices places a VOIP call to the first computing device, the first computing device automatically answers the call and establishes an active VOIP session over the VOIP connection. Automatic answering of the call may be performed without the user of the first computing device having to perform additional actions, beyond speaking. In one embodiment, a display may be provided at the first computing device indicating that the user of the second computing device may be “listening” over the established VOIP connection.

In one embodiment, the status message to the second computing device may indicate a topic, event, talk shows, or the like, for which the user of the first computing device is available for automatic VOIP connections. In one embodiment, the user of the first computing device may also provide an entry point off of a website, within an email, or the like, for use in placing the VOIP call. The entry point may include an HTTP hyperlink, a script, a tag, an applet, a mime action, or the like. When another user goes to the website, email, or the like, the other user may select the entry point and initiate the VOIP call with the user. Moreover, in one embodiment a micro-browser, or the like, may be displayed for the other user. In one embodiment, the micro-browser may display information about an event, topic, or the like, including, statistics, graphics, movies, pictures, biographies, or the like.

Moreover, N other computing devices in the plurality of computing devices may also place a VOIP call to the first computing device, which may be automatically answered by the first computing device to establish an N-way active VOIP conferencing session.

In one embodiment, data may be gathered based on a topic, event, talk show, or the like, including the number of users that selected to participate in the VOIP session, number of users that selected automatic VOIP connections, amount of time users participated in the automatic VOIP connection, or the like.

Illustrative Operating Environment

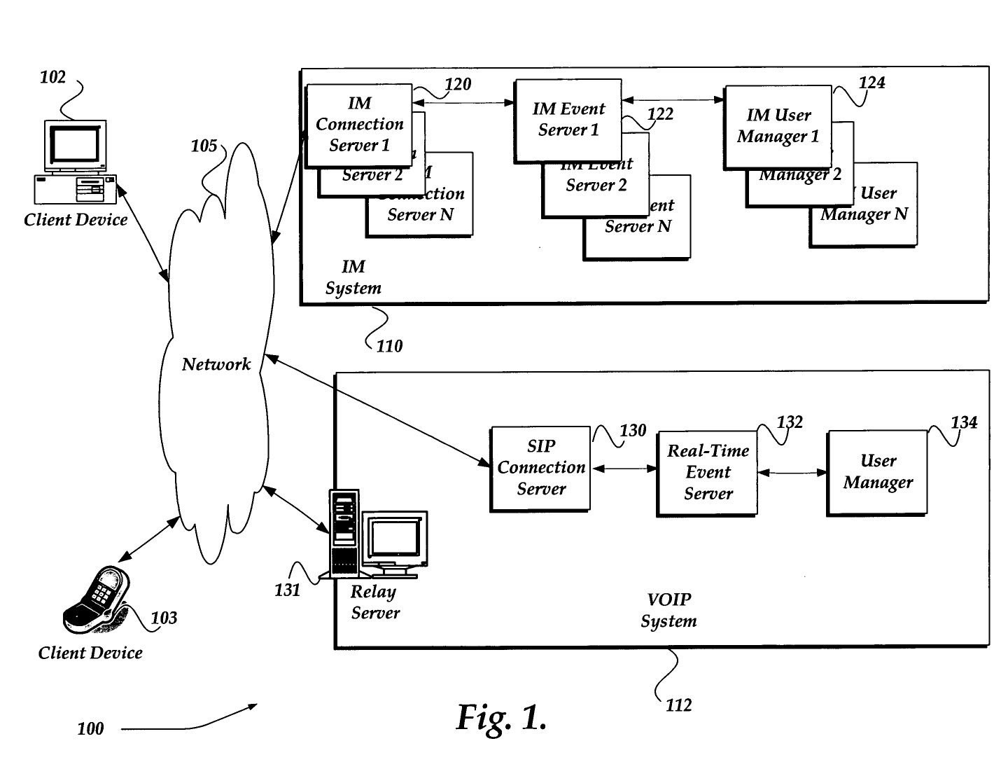

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, system 100 includes client devices 102-103, network 105, IM system 110, and VOIP system 112. IM system 110 may include IM connection servers 120, IM event servers 122, and IM user managers 124. VOIP system 112 includes relay server 131, SIP connection server 130, real-time event server 132, and user manager 134.

Client device 102 is in communication with IM connection servers 120, SIP connection server 130, and relay server 131 through network 105. Client device 103 is in communication with IM connection servers 120, SIP connection server 130, and relay server 131 through network 105. IM event servers 122 are in communication with IM connection servers 120 and IM user managers 124. Real-time event server 132 is in communication with SIP connection server 130 and user manager 134.

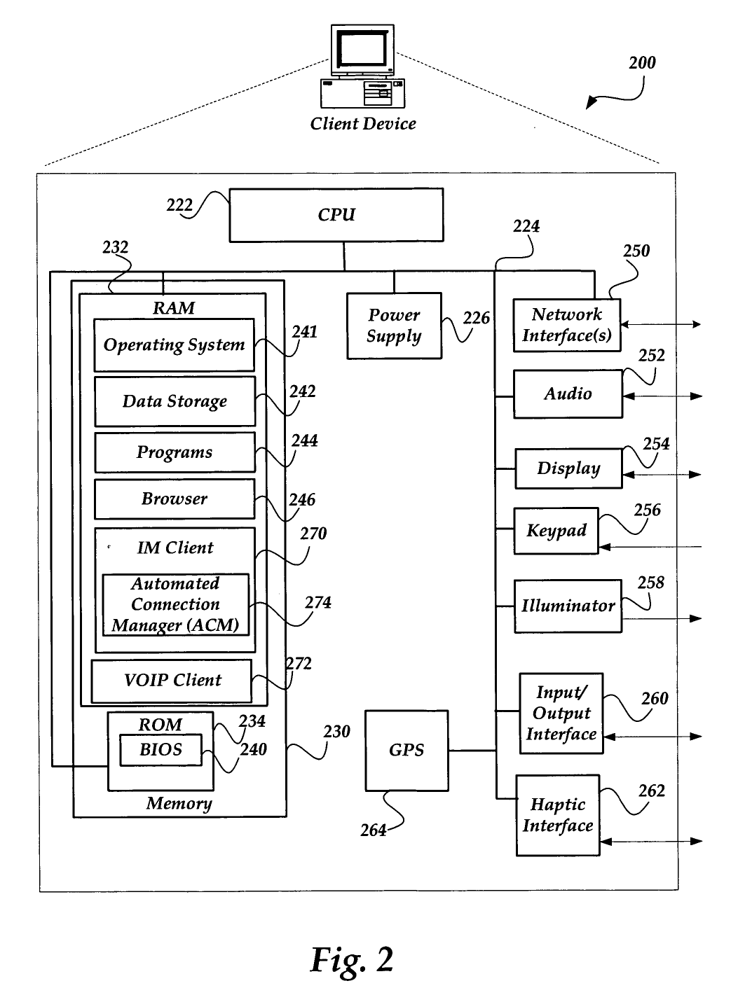

One embodiment of client devices 102-103 is described in more detail below in conjunction with FIG. 2. Briefly, however, client devices 102-103 may include virtually any device that is arranged to send and receive communications and messages such as VOIP messages via one or more wired and/or wireless communication interfaces. For example, client device 103 may be configured to send and/or receive VOIP messages with client device 102 through relay server 131.

Typically, client devices 102-103 may be configured to communicate using any of a variety of protocols. For example, client devices 102-103 may be configured to employ RTP for communicating media data such as audio and video to another device. However, the invention is not so limited, and another media data mechanism may be employed, including IAX, and the like. Client devices 102-103 may also employ the SIP protocol for enabling setting up a session and enabling such actions as dialing a number, enabling a ring, a ring-back tone, busy signal, and the like. However, other signaling protocols may also be employed, including H.323, Skinny Client Control Protocol (SCCP), IAX, MiNET, and the like. Typically, however, client devices 102-103 may employ SIP over either UDP or TCP and RTP over UDP.

Client devices 102-103 may include a client application that enables an automated VOIP connection status such that a VOIP call from another computing device may be automatically answered, establishing an active VOIP session over a connection. Moreover, client application may also provide a status message to the other computing device indicating its automated VOIP connection status. In one embodiment, the status message may be provided to the other computing device based on a list of known users. For example, in one embodiment, the status may be provided based on an instant messaging buddy list, an email address book contact list, a phone contact list, or the like. However, the invention is not so limited. The status message may also be provided to other computing devices independent of whether the recipients of the status message are known to the user of the client device. For example, the status message may be broadcast to members of a group, club, organization, or the like. The status message may also be made available at a website for others, potentially unknown to the user of the client device, to access. Thus, the status message may be provided using email, IM, SMS, a website, or the like. Moreover, in one embodiment, the status message may include additional information indicating an event, topic, or the like, for which the user of the client device is available to receive an automated VOIP call.

The client application within client devices 102-103 may further receive a VOIP call from the other computing device and, based, in part, on the client device's automated VOIP connection status, automatically answer the received call and enable an active VOIP session with the caller. Moreover, the client application may provide a message indicating that the VOIP session with the caller is active. In one embodiment, the client application may be an IM client application. In another embodiment, the client application is a component of an application, such as the IM client application, or the like. However, the invention is not so limited, and the client application may be a separate application that may also interact with an IM application, a VOIP application, or the like.

In addition, client devices 102-103 may also be configured to provide an identifier, sometimes known as an originating line identifier (OLI) during a communication. The identifier may employ any of a variety of mechanisms, including a device model number, a carrier identifier, a mobile identification number (MIN), and the like. The MIN may be a telephone number, a Mobile Subscriber Integrated Services Digital Network (MS-ISDN), an electronic serial number (ESN), or other device identifier. The OLI may also be an IP address associated with client devices 102-103. In one embodiment, the identifier is provided with each communication. In another embodiment, the identifier is provided by an end-user. In one embodiment, the identifier may be associated with a user. For example, the identifier may be used to search a data store to locate a user-identifier, or the like. The user-identifier may then be provided to another client device for use in indicating an automatic VOIP connection status, or the like.

Devices that may operate as client devices 102-103 include devices that typically connect using a wired communications medium such as personal computers, desktop computers, multiprocessor systems, microprocessor-based or programmable consumer electronics, network PCs, and the like. The set of such devices may also include devices that typically connect using a wireless communications medium such as cell phones, smart phones, pagers, walkie talkies, Personal Digital Assistants (PDAs), handheld computers, programmable consumer electronics, an IP phone, radio frequency (RF) devices, infrared (IR) devices, CBs, integrated devices combining one or more of the preceding devices, or virtually any mobile device, and the like. Similarly, client devices 102-103 may be any device that is capable of connecting using a wired or wireless communication medium such as a PDA, POCKET PC, wearable computer, and any other device that is equipped to communicate over a wired and/or wireless communication medium.

Network 105 is configured to couple one computing device to another computing device to enable them to communicate. Network 105 is enabled to employ any form of computer readable media for communicating information from one electronic device to another. Also, network 105 may include a wireless interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 may include any communication method by which information may travel between computing devices.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

IM system 110 is configured to manage IM sessions between client devices employing an IM client application. IM system 110 may employ IM connection servers 120, IM event servers 122, and IM user managers 124 to manage one or more IM sessions. In one embodiment, IM connection servers 120, IM event servers 122, and IM user managers 124 may represent separate server processes operating with a single computing device. In another embodiment, IM connection servers 120, IM event servers 122, and IM user managers 124 may represent distinct processes operating across multiple computing devices. As such, IM system 110 may be implemented on a variety of computing devices including personal computers, desktop computers, multiprocessor systems, microprocessor-based devices, network PCs, servers, network appliances, and the like.

IM connection servers 120 are configured to receive a request to establish an IM session from an IM client, such as might be included within client devices 102-103, and the like. IM connection servers 120 may also receive from the IM client authentication information that may be employed to authenticate an end-user of the IM client. If the end-user is authenticated, IM connection servers 120 may enable the IM client to log into the IM session. IM connections servers 120 may also be configured to provide information about the established session to IM event servers 122.

IM connections servers 120 may also forward various request information from the IM client to IM event servers 122. Such request information may include, for example, a request to locate and communicate with another IM end-user.

IM event servers 122 are configured to receive the end-user's log in and other request information from IM connections servers 120. IM event servers 122 may request IM user managers 124 to store information about the IM client and end-user. IM user mangers 124 may employ a table, spreadsheet, file, database, and the like, to register the IM client, and on which IM connection server, within IM connection servers 120, the IM client is logged into. Thus, IM user managers 124 may store information about various IM conversations that may include such information as identifiers for end-users associated with an IM conversation, time information, account identifiers for the end-users, IM connection servers associated with an IM conversation, and so forth. In addition, the stored information may also include a status indicating whether the IM client is open and available for an automated VOIP connection, and/or whether an event, topic, talk show, or the like, may be associated with the status. As such, IM event servers 122 may also employ IM user managers 124 to determine which IM connection server, within IM connection servers 122, another end-user is logged into, and provide such information to IM connection servers 120, so that an IM session may be established between two or more IM end-users. In one embodiment, IM connection servers 122 may also send a status message to one or more IM end-users indicating whether an end-user's device is configured to automatically answer a VOIP call. The status message may also indicate whether the user is open to a topic, event, talk show, or the like.

VOIP system 112 is configured to manage VOIP sessions between client devices using any of a variety of VOIP protocols. As shown, VOIP system 112 may be implemented in a single computing device, with each of the illustrated components operating as one or more processes with the single computing device. VOIP system 112 may also be implemented across multiple computing devices, with one or more of the illustrated components distributed across the multiple computing devices. As such VOIP system 112 may be implemented on a variety of computing devices including personal computers, desktop computers, multiprocessor systems, microprocessor-based devices, network PCs, servers, network appliances, and the like.

Relay server 131 is configured to manage messages, such as media messages between one computing device and another, such as client devices 102-103, and the like. Relay server 131 may, for example, receive a VOIP packet, such as a TCP/IP packet and relay it towards a destination device. Relay server 131 may also be configured to monitor flow congestion, quality of service characteristics, and the like, associated with a communication between itself and the destination device, and/or the source device. Devices that may operate as relay server 131 include personal computers, desktop computers, multiprocessor systems, microprocessor-based or programmable consumer electronics, network PCs, servers, firewalls, gateways, network address translators, bridges, routers, and the like.

SIP connection server 130 is configured to receive a request to establish a SIP connection from client devices 102-103, and the like. The requesting device may provide identification information to SIP connection server 130 that may be used, at least in part, to authenticate the request to establish the SIP connection. If the requesting device is authenticated, SIP connection server 130 may enable the requesting device to log into a connection. SIP connection server 130 may also provide information about the requesting device to real-time event server 132. Real-time event server 132 may be configured to receive the information and provide it to user manager 134 for storage.

User manager 134 may store the information in a database, spreadsheet, table, file, and the like. Such information may include, for example, an identifier associated with the requesting device, an end-user associated with the requesting device, an address associated with SIP connection server 130, and the like. User manager 134 may receive and manage such information for a plurality of requesting devices. User manager 134 may also provide information to real-time event server 132 about at least one other requesting device, such that SIP connection server 130 may enable a VOIP communication between one or more end-user devices, such as client devices 102-103, and the like. In one embodiment, the one or more end-user devices may employ relay server 131 to relay the VOIP communications between them. For example, SIP connection server 130 may provide a token, certificate, ticket, or similar authentication/authorization mechanism, to the one or more client devices. The one or more client devices may then provide the authentication/authorization mechanism to relay server 131 to establish the communications.

Illustrative Client Device

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. As shown in the figure, client device 200 includes a processing unit 222 in communication with a mass memory 230 via a bus 224.

Client device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or the like.

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, and the like. Haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS and the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 242, which can be utilized by client device 200 to store, among other things, programs 244 and/or other data. For example, data storage 242 may also be employed to store information that describes various capabilities of client device 200. The information may then be provided to another device based on any of a variety of events, including being sent as part of a header during a communication, sent upon request, and the like.

Programs 244 may include computer executable instructions which, when executed by client device 200, transmit, receive, and/or otherwise process messages (e.g., SMS, MMS, IM, email, and/or other messages), audio, video, and enable telecommunication with another user of another client device. Other examples of application programs include calendars, contact managers, task managers, transcoders, database programs, word processing programs, spreadsheet programs, games, codec programs, and so forth. In addition, mass memory 230 stores browser client 246, IM client 270, and VOIP client 272. Moreover, IM client 270 includes Automated Connection Manager (ACM) 274.

Browser 246 may be configured to receive and to send web pages, web-based messages, and the like. Browser 246 may, for example, receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like.

VOIP client 272 is configured to enable client device 200 to initiate, receive, and manage a VOIP session with another client device. VOIP client 272 may employ the SIP protocol for managing signaling, and RTP for transmitting the VOIP traffic (“media”). However, the invention is not so constrained, and any of a variety of other VOIP protocols may be employed including IAX which carries both signaling and voice data, H.323, SCCP, Megaco, MGCP, MiNET, Skinny Client Control Protocol (SCCP), and the like. VOIP client 272 is further configured to employ virtually any media codec to compress the media stream for communicating it over the network, including G.711, G.729, G.729a, iSAC, Speex, and the like. In one embodiment, SIP may be employed to enable a Session Description Protocol (SDP).

VOIP client 272 may be further configured to manage a flow of VOIP packets to and/or from another computing device. In one embodiment, VOIP client 272 may employ these components to provide the packets using RTP with Real-time Control Protocol (RTCP). VOIP client 272 may employ an RTCP report from a destination device to determine various qualities of communications, including flow control, congestion control, quality of service, and the like.

IM client 270 may be configured to initiate and manage an instant messaging session, including, but not limited to AOL Instant Messenger, Yahoo! Messenger, .NET Messenger Server, ICQ, and the like. In one embodiment, IM client 270 is configured to employ a VOIP client, such as VOIP client 272 to integrate IM/VOIP features. Thus, in one embodiment, IM client 270 may employ SIP to establish media sessions with another computing device employing an IM/VOIP capable client, and RTP to communicate the media traffic. However IM client 270 is not so limited. For example, IM client 270 may also employ any of the following SIMPLE (SIP for Instant Messaging and Presence Leverage), APEX (Application Exchange), Prim (Presence and Instant Messaging Protocol), the open XML-based XMPP (Extensible Messaging and Presence Protocol), more commonly known as Jabber and OMA (Open Mobile Alliance)'s IMPS (Instant Messaging and Presence Service) created specifically for mobile devices, and the like.

As shown, IM client 270 may also include ACM 274 which is configured to enable status-based automatic answering and conferencing for presence-enabled VOIP communications. For example, a user may employ ACM 274 to configure VOIP client 272 to automatically answer an incoming VOIP call, and to establish an active VOIP call with the calling device. ACM 274 may also provide a status message to another computing device indicating that the user of client device 200 is available for automatically answering a VOIP call. The status message may include additional information indicating an event, topic, talk show, or the like, in which the user would be open to participate. In one embodiment, ACM 274 may employ any of a buddy list, contact list, email list, or the like, to select a recipient of the status message.

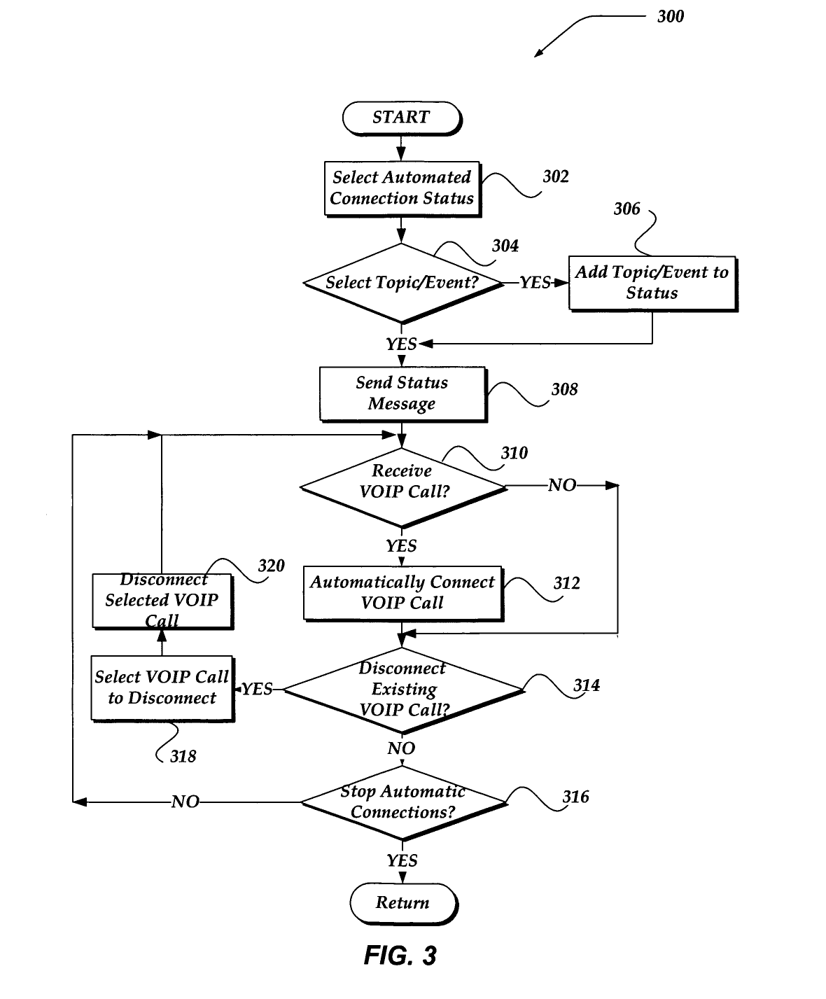

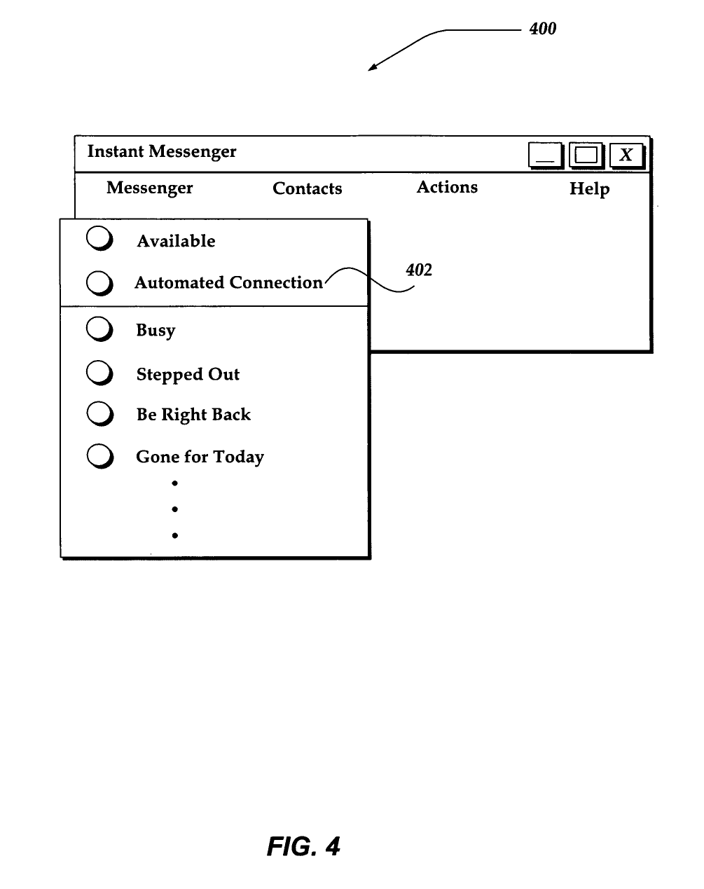

When a VOIP call is automatically answered, ACM 274 may enable a display to be provided to the user of client device 200 indicating that the incoming VOIP call has been automatically answered and the caller may be listening. The display may include a mechanism that enables the user of client device 200 to disconnect the automatically answered VOIP call, stop automatic answering, or the like. ACM 274 may employ a process substantially similar to that described below in conjunction with FIG. 3 to perform at least some of its actions. Moreover, ACM 274 may enable display of at least some of the screens illustrated in FIGS. 4-9.

Although not shown, client device 200 may also be configured to receive a message from another computing device, employing another mechanism, including, but not limited to email, Short Message Service (SMS), Multimedia Message Service (MMS), internet relay chat (IRC), mIRC, and the like. As such, ACM 274 is not constrained to IM client 270, and other mechanisms may be employed to provide status messages, and enable automatic answering of a VOIP communications. Moreover, ACM 274 need not be constrained to client device 200. For example, in one embodiment of the invention at least some of its actions may be performed at a server. Thus, in one embodiment, selecting an automated connection status, selecting a topic/event, and/or sending of a status message may be performed one or more components within IM system 110 of FIG. 1. Moreover, at least some other actions of ACM 274 may be performed within VOIP system 112 of FIG. 1. For example, one of more components of VOIP system 112 may perform such actions as automatic answering, disconnecting, and/or terminating an automated connection status.

Generalized Operation

The operation of certain aspects of the invention will now be described with respect to FIG. 3. FIG. 3 illustrates a logical flow diagram generally showing one embodiment of a process for automatically managing a VOIP connection over a network. Process 300 of FIG. 3 may be implemented in a client device, such as client devices 102-103 of FIG. 1, for example. Moreover, FIGS. 4-9, which are described in more detail below, illustrate embodiments of possible screen displays useable during the automatic VOIP connection process of FIG. 3.

As shown in process 300 begins, after a start block, at block 302, where an automated VOIP connection status is selected at a client device. Automated VOIP connection status may be selected through, for example, an IM client interface, an SMS interface, a web browser, or the like. Selection of the automated VOIP connection status may enable the client device to establish a VOIP connection with the caller by automatically answering a VOIP call, and establishing an active VOIP session.

Process 300 continues to decision block 304 where a determination is made whether the VOIP connection status is to include information associated with an event, topic, talk show, or the like. Such information is intended to provide to a user of another computing device an indication of a subject in which the user of the client device is available to participate in a VOIP communications. If no such additional information is to be added, processing flows to block 308. Otherwise, if such additional information is to be added to the VOIP connection status, processing branches to block 306 where the user of the client device may enter the information. The information may be entered using any of a variety of mechanisms, including, but not limited to, using a pull-down menu, a fill-in the blank, or the like. In any event, upon entering the additional VOIP connection status information, processing flows to block 308.

At block 308, a status message may be sent to one or more potential callers. In one embodiment, the status message is sent to potential callers based on a contact list, buddy list, email list, or the like. The status message may include, for example, an indication that the client device is configured to automatically answer a VOIP call. The status message may further indicate, based, in part, on block 306, a topic, event, talk show, or the like, in which the user is available to participate. At this juncture, the user has set up for use of automatic VOIP connections. The user may now perform other actions until one or more VOIP calls are received, or the user decides to terminate the automatic connection status.

Thus, process 300 continues to decision block 310 where a determination is made whether a VOIP call is received. The VOIP call may be placed by a caller using any of a variety of mechanisms, including an IM client application, a web browser, an SMS client application, or the like. In any event, if a VOIP call is received, processing continues to block 312; otherwise, processing branches to decision block 314.

At block 312, the received VOIP call is automatically answered and a VOIP connection is established such that a VOIP session with the caller is established. In one embodiment, the user of the client device (recipient) to which the call is placed, may hear a connection tone, however, neither the caller nor the recipient may hear a ring tone. However, the invention is not so limited, and in one embodiment, a ring tone may be provided. In one embodiment, the recipient of the call may be provided a display that indicates who has called and established a VOIP session. In another embodiment, although not shown, an updated status message may be sent to one or more potential callers (including the current caller), indicating that the recipient is currently connected with a caller. As additional callers may establish VOIP connections with the recipient, the status message may also, in one embodiment, indicate a number of callers with which the recipient is connected.

Processing continues next to decision block 314, where a determination is made whether the recipient is to disconnect an existing VOIP call. If the recipient is to disconnect an existing VOIP call, processing flows to block 318; otherwise processing continues to decision block 316.

At decision block 316, a determination is made whether the recipient is to terminate its automatic VOIP connection status. If automatic VOIP connection status is to be terminated, processing returns to a calling process where, among other actions, the automatic VOIP connection status is terminated. In one embodiment, another status message may be sent to one or more potential callers indicating another status of the recipient, including such as off-line, not available, busy, or the like. If however, the recipient is not to terminate VOIP connection status, processing loops back to decision block 310. By returning to decision block 310, additional VOIP calls may be received resulting in automatic answering of VOIP conference calls.

At decision block 314, where an existing VOIP call is to be disconnected processing continued to block 318, where a VOIP call is selected. In one embodiment, selection of the VOIP call may be performed using a display interface. However, the invention is not so limited, and virtually any other mechanism, including entry of a caller identifier, or the like, associated with the VOIP call to be disconnected. Processing continues to block 320, where the selected VOIP call is then disconnected. In one embodiment, a status message may be sent to the caller associated with the disconnected call. In another embodiment, another status message may be sent to the one or more potential callers, indicating that the recipient is no longer connected to the VOIP call, a decremented a number of connections, or the like. Processing then loops back to decision block 310 to continue until the recipient terminates VOIP connection status, or additional automatic VOIP calls are answered to provide for automatic answering for VOIP conference calls.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions. Moreover, at least some of the blocks of the flowchart illustration, and combinations of some of the blocks in the flowchart illustration, can also be implemented using a manual mechanism, without departing from the scope or spirit of the invention.

FIGS. 4-9 illustrate one embodiment of possible screen displays displayable during an automatic VOIP connection, in accordance with the present invention. Such screen displays are not to be considered as limiting the invention, but rather are provided as but one possible implementation of a mechanism for providing status and/or an input mechanism for selecting various options associated with automatic VOIP connections.

Thus, one embodiment of a screen display for use in selecting an automated VOIP connection status is shown in FIG. 4 as display 400. Display 400 employs an IM client interface. As shown, display 400 includes automated connection selection 402 which may include an icon, button, or the like, that, when selected, enables an automated VOIP connection. In one embodiment, display 400 may be employed by during block 302 of process 300 described above.

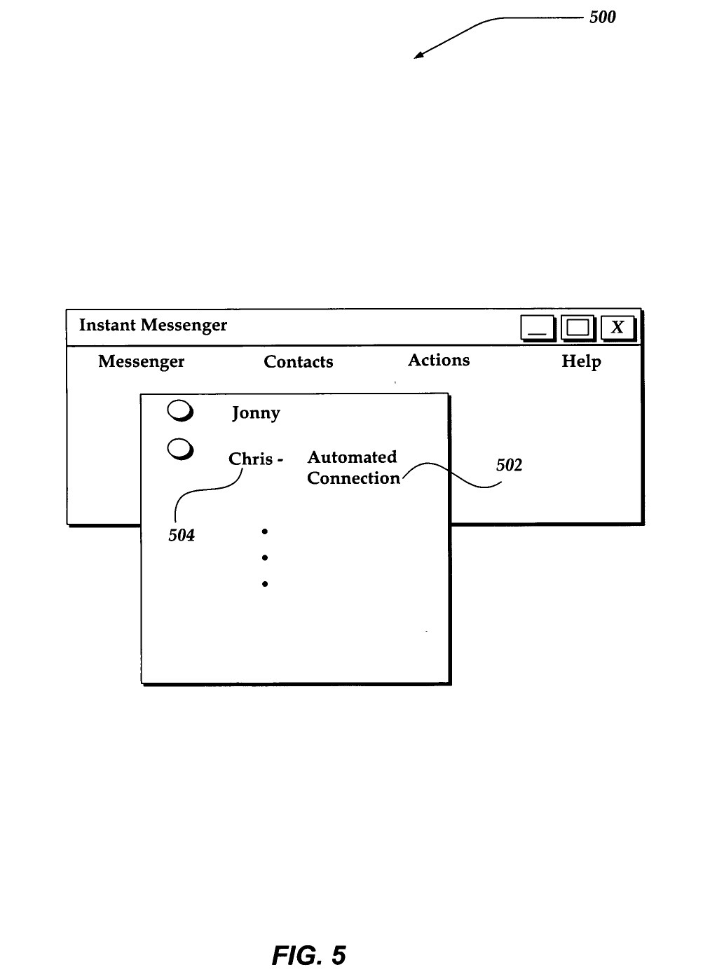

One embodiment of a screen display for use in indicating to a potential caller an automated VOIP connection status is shown in FIG. 5 as display 500. As shown, display 500 illustrates automated connection status 502 for potential call recipient 504. Such indication may be illustrated using a variety of mechanisms, including text, a graphic, a combination of text and graphic, or the like. Display 500 may be employed, for example, during block 308 of process 300.

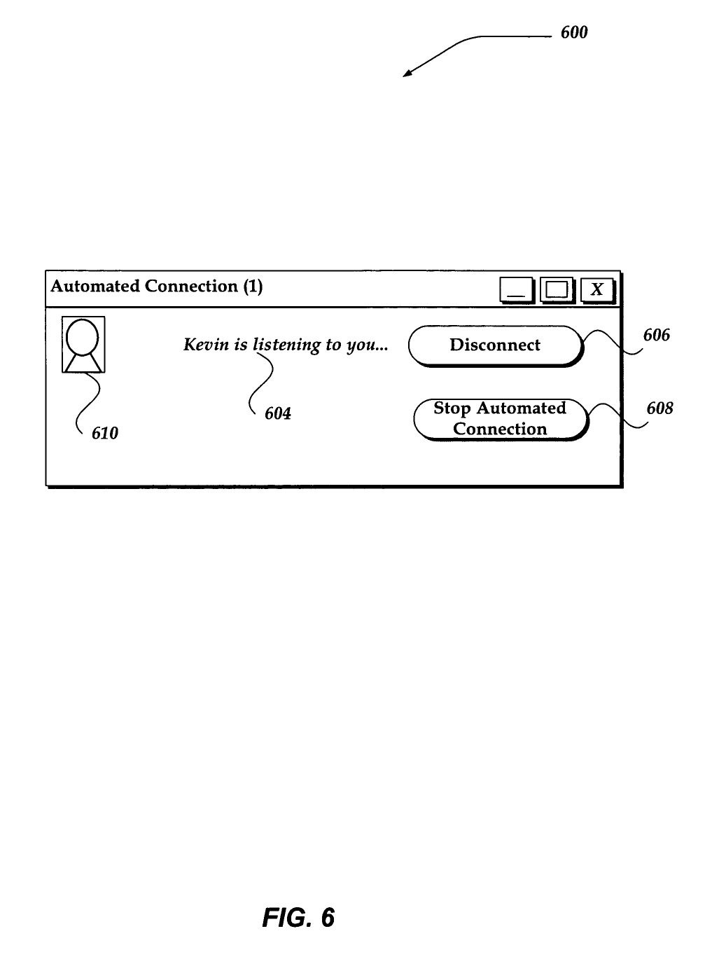

One embodiment of a screen display for use in managing an automated VOIP connection status is shown in FIG. 6 as display 600. As illustrated, display 600 includes caller identifier 604, disconnect selector 606, and stop selector 608. Caller identifier 604 includes an identifier associated with the caller that may be currently connected with the recipient through an active VOIP session. Any of a variety of identifiers may be employed including a graphic such as graphic 610, a caller's name, or other moniker. In one embodiment, caller identifier 604 may also include information indicating that the caller has established an active VOIP session. Disconnect selector 606 may include a button, icon, pull-down menu, or the like, that enables the recipient to select a caller to be disconnected. Stop selector 608 may include a button, icon, pull-down menu, or the like, that enables the recipient to terminate the automated VOIP connection status. In one embodiment, termination of the automated VOIP connection status may also disconnect the one or more callers; however, the invention is not so limited. Thus, in one embodiment, the termination of the automatic VOIP connection status may allow existing callers to remain active, but inhibit automatic answering of another VOIP call. In one embodiment, display 600 may be used during blocks 312, 314, 316, and/or 318 of process 300.

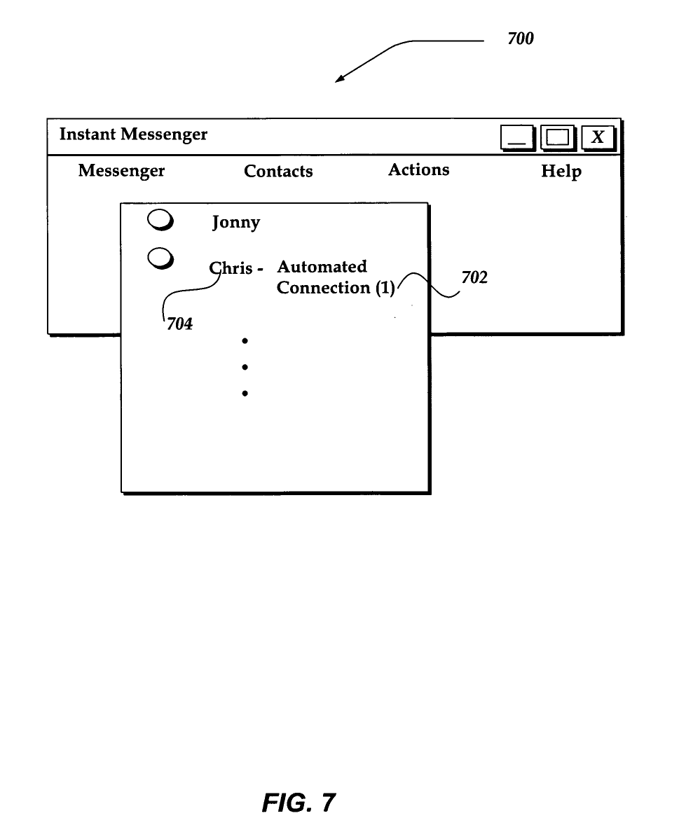

One embodiment of a screen display for use in indicating an automated VOIP connection status to a potential caller is shown in FIG. 7 as display 700. As shown in the figure, display 700 may include status message 702 associated with potential call recipient 704. As indicated, status message 702 may further indicate a number of active VOIP sessions in which potential call recipient 704 is currently associated. Display 700 may be employed for example during block 314 of process 300 by one or more potential callers.

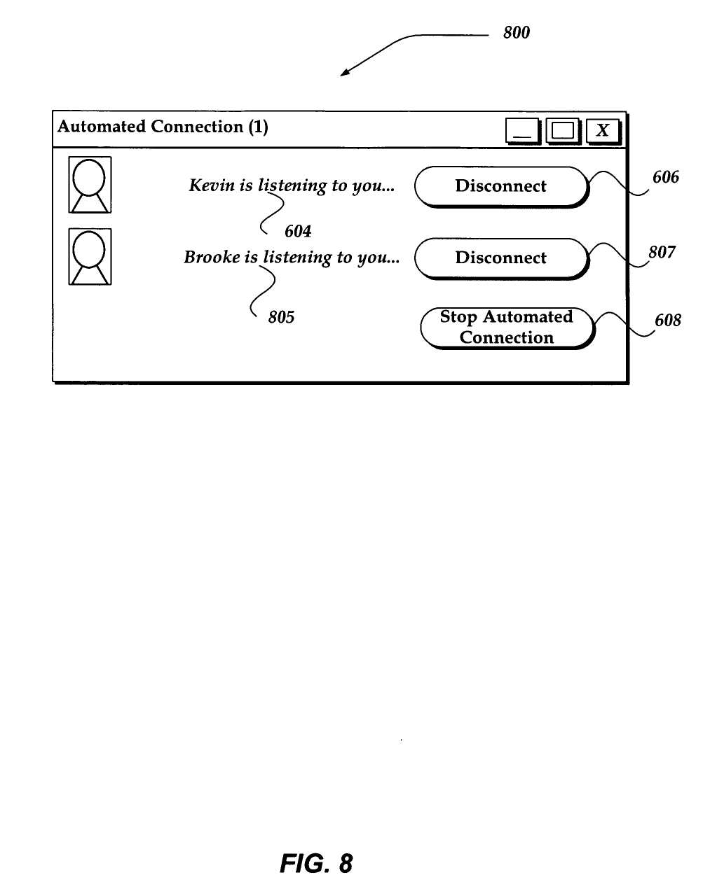

One another embodiment of a screen display for use in managing an automated VOIP connection status is shown in FIG. 8 as display 800. As illustrated, display 800 includes caller identifiers 604 and 805, disconnect selectors 606 and 807, and stop selector 608. Caller identifiers 604 and 805 are substantially similar to caller identifier 604 described above; however each caller identifier may be associated with a different caller. Similarly, disconnect selectors 606 and 807 are substantially similar to disconnect selector 606 described above; however, each disconnect selector is associated with a different caller. Stop selector 608 is substantially similar to stop selector 608 described above. Display 800 thus illustrates that a recipient may be enabled to manage a plurality of active VOIP sessions.

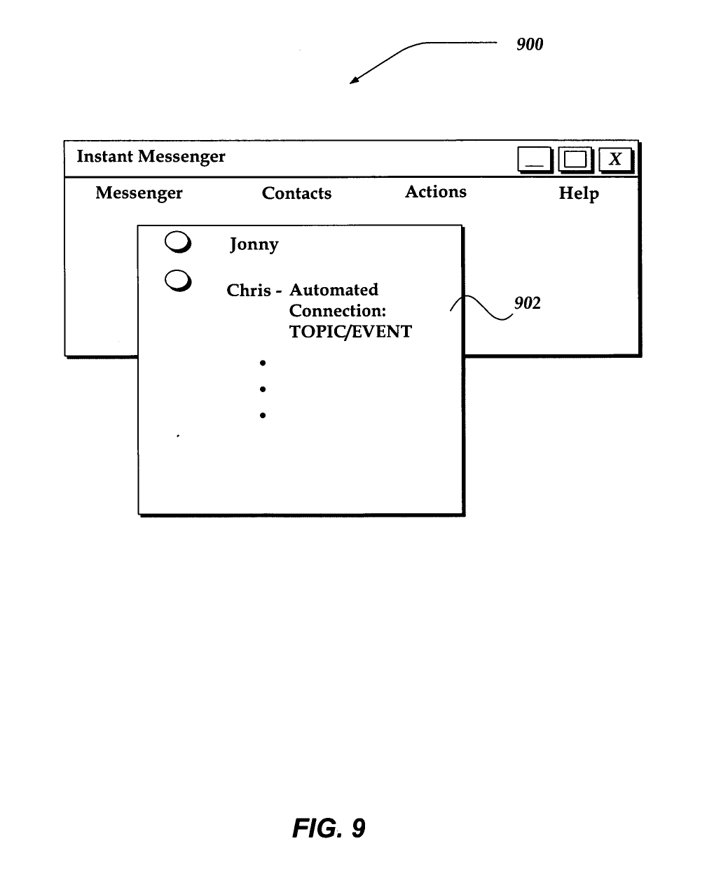

One embodiment of a screen display illustrating a topic/event status for an automated VOIP connection is shown in FIG. 9 as display 900. As illustrated, display 900 includes automated connection status with topic/event indication 902. Topic/event indication 902 indicates at least one topic, event, talk show, or the like in which the potential call recipient is available to participate. In one embodiment, display 900 may be employed during blocks 306 and/or 308 of process 300 above. Moreover, although not illustrated, when one or more VOIP sessions are established with the recipient, each of the caller's status may also be revised to indicate that the caller is in a call; that the caller is in a call associated with a topic, event; or the like.

Although as described above, a user of the invention may provide a status message to one or more potential callers, the status message may be also provided using a variety of mechanisms. For example, in one embodiment, the user of the invention may also provide an entry point to one or more potential callers through a website. Such entry point may include, for example, a graphic, hyperlink, or the link, for which a potential caller may select. In one embodiment, a Uniform Resource Locator (URL), or the like, indicating how to access the website may be provided in a status message to the one or more potential callers. In one embodiment, the entry point may create a mime action, such as:
Ymsgr:autoconnect?message=TOPIC! Watching topic&url=URL.com

The example mime action may then enable the user to establish an automated VOIP connection with a topic “TOPIC! Watching topic” and associate a URL with the session of URL.com. Thus, in at least one embodiment, the potential caller may be initially unknown to the call recipient.

Furthermore, if a potential caller is at a website, through a partnership, promotion, or the like, a banner, or the like, to the mime action may be made available. When a potential caller clicks on the banner, or the like, to establish an automated VOIP connection, a client application may also open a micro-browser, or the like, to the specified—URL.com—which can provide additional context, status about the topic, or the like.

In one embodiment, information associated with use of the automated VOIP connection may also be tracked. For example, in one embodiment, a number of users who clicked on the banner, or the like, to set their status; a number of users who joined an automated VOIP session; a total number of users that connected to talk about the topic; an amount of time an automated VOIP session is active; a total amount of time a plurality of automated VOIP sessions are active; information associated with the micro-browser; or the like.

Such mechanisms may be directed towards a variety of topics, including sports, reality shows, game shows, finances, automobiles, education, television shows, or the like. For example, in one embodiment, a user may send an automated VOIP connection status indicating a town hall type of discussion. The status message may then be provided to a variety of sources such that it is available publicly, including a newspaper, a blog, a publicly available list of topics, or the like. Callers may then select to “tune-in” to the town hall talk to participate. Such town halls may be associated with a variety of topics, including dating advice, car repair, fashions, repairs computers, coding, bargain hunting, medical advice, or the like. In one embodiment, such town halls may be advertised at a website through a searchable list, scroll-down list of active town halls, or the like.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A client device that is configured to manage a Voice Over IP (VOIP) connection, comprising:
a transceiver for receiving and for sending information over the network; and
program code that is arranged to perform actions comprising:
establishing an automated connection status;
receiving a VOIP call from another computing device; and
in response, automatically establishing a VOIP connection between the other computing device and the client device, wherein establishing the VOIP connection comprises automatically answering the VOIP call and establishing a VOIP session.

2. The client device of claim 1, the actions further comprising sending a message to the other computing device that the client device is available to automatically answer the VOIP call.

3. The client device of claim 1, wherein receiving the VOIP call further comprises the other computing device placing the VOIP call through at least one of an instant messenger, or a web browser.

4. The client device of claim 1, the actions further comprising sending a status message that includes at least one of a topic, an event, a talk show, or a town hall discussion to the other computing device.

5. The client device of claim 1, wherein at least one of the client device or the other computing device is a mobile device.

6. The client device of claim 1, wherein automatically establishing the VOIP connection further comprises displaying at the client device information indicating that the VOIP connection is established.

7. The client device of claim 1, wherein the actions further comprising:
receiving another VOIP call from a third computing device; and
automatically establishing a VOIP conference call session.

8. A method for managing a Voice Over IP (VOIP) connection, comprising:
sending an automated VOIP connection status;
receiving a VOIP call; and
automatically establishing a VOIP connection, wherein establishing the VOIP connection comprises automatically answering the VOIP call and establishing a VOIP session.

9. The method of claim 8, wherein sending an automated VOIP connection status further comprises employing at least one of a buddy list, an email address book, or a phone contact to send the automated VOIP connection status.

10. The method of claim 8, further comprising:
receiving another VOIP call; and
automatically establishing another VOIP connection by automatically answering the other VOIP call and establishing at least a three-way VOIP conference call session.

11. The method of claim 8, wherein sending the automated VOIP connection status further comprises sending a status message indicating at least one of a event, a topic, a talk show, or a town hall discussion.

12. The method of claim 8, further comprising:
tracking information including at least one of a number of users requesting a VOIP call, an amount of time that an automated VOIP session is active, information associated with an event, or information associated with a topic of the call.

13. A modulated data signal that is configured to include program instructions for performing the method of claim 8.

14. A system for use in managing a Voice Over IP (VOIP) connection, comprising:
a first computing device that is configured to perform actions comprising:
establishing an automated VOIP connection status;
receiving a VOIP call; and
in response, establishing a VOIP connection, in part, by automatically answering the VOIP call and establishing a VOIP session; and
a second computing device, in the plurality of computing devices, being configured to perform actions, comprising placing the VOIP call with the first computing device.

15. The system of claim 14, wherein the first computing device is configured to perform actions further comprising:
enabling a user of the first computing device to disconnect the VOIP connection.

16. The system of claim 14, the second computing device being configured to perform actions further comprising:
selecting at least one of a website, an IM, or an SMS mechanism to place the VOIP call.

17. The system of claim 14, wherein the first computing device is programmed to perform actions further comprising:
receiving another VOIP call from a third computing device in the plurality of computing devices; and
automatically establishing another VOIP connection that establishes a VOIP conference call.

18. The system of claim 14, wherein placing the VOIP call further comprises using at least one of an instant messenger (IM), SMS, or a web browser, in part, to place the VOIP call.

19. The system of claim 14, wherein establishing an automated connection status further comprises sending a status message that includes information associated with at least one of a topic, an event, a talk show, or a town hall activity.

20. A computer-readable medium having computer-executable instructions for performing steps for use in managing a Voice Over IP (VOIP) connection, the steps comprising:
establishing an automated VOIP connection status;
receiving a VOIP call from a computing device;
automatically answering the VOIP call; and
automatically establishing a VOIP connection with the computing device.

21. The computer-readable medium of claim 20, the steps further comprising sending a message to the other computing device indicating availability to automatically establish the VOIP connection.

22. The computer-readable medium of claim 20, wherein receiving the VOIP call further comprises the other computing device placing the VOIP call through at least one of an instant messenger, or a web browser.

23. The computer-readable medium of claim 20, the steps further comprising sending a status message that includes information that associates the status to at least one of a topic, an event, a talk show, or a town hall discussion to the other computing device.

24. The computer-readable medium of claim 20, wherein at least some of the steps are performed on a client device and at least some other of the steps are performed on a server.
